(19) United States
(12) Patent Application Publication
(10) Pub. No.: US 2014/0229263 A1
(43) Pub. Date: Aug. 14, 2014

(54) ON-SITE REWARDS PROGRAM

(71) Applicants: Vladimir Edelman, Carlsbad, CA (US); Trent Dethloff, Carlsbad, CA (US)

(72) Inventors: Vladimir Edelman, Carlsbad, CA (US); Trent Dethloff, Carlsbad, CA (US)

(21) Appl. No.: 13/746,256

(22) Filed: Jan. 21, 2013

(51) Int. Cl. G06Q 30/02

(52) U.S. Cl. CPC G06Q 30/0226
USPC 705/14.27

(57) ABSTRACT

A method of providing a loyalty rewards program, comprising receiving an electronic order for a purchase of goods or services from a personal communication device operated by a consumer over a communication interface, determining a location of the personal communication device, electronically awarding rewards points by a processor to an account associated with the consumer stored in memory based on purchases of goods or services placed through the personal communication device by the server only if the personal communication device is located at a merchant's premises, the merchant authorized to participate in the loyalty rewards program.

### BACKGROUND

I. Field of Use

The present application relates to the loyalty programs, otherwise known as rewards programs.

II. Description of the Related Art

Incentive award programs have been used in a variety of industries to promote customer loyalty. Generally, such programs reward customers for repeat business with the same merchant or service provider by accumulating rewards points which can then be redeemed in a number of ways, including exchanging the rewards points for goods and services that may be selected from an approved list or a redemption catalog, for example. The rewards points are usually calculated using a predetermined formula or ratio that relates a customer's purchase volume (i.e., in terms of money value or some other volume parameter) to a certain number of rewards points. For example, rewards points may be issued on a one-for-one basis with each dollar that a customer spends on particular goods and services.

One well-known example of a customer incentive program is a “frequent flyer” program that rewards airline passengers with “mileage points” based upon the distances that the passengers fly with a particular airline. The mileage points may then be redeemed for free airfare or free car rentals. Other incentive award programs are designed to induce usage of particular financial instruments, such as credit cards or debit cards, by accumulating rewards points or dollar value points based upon the volume of purchases made using the particular financial instrument. These types of programs may be designed such that customers of the financial institution accumulate rewards points which can be redeemed for selected goods or services or, alternatively, such that customers accumulate points which have a dollar value which can be applied toward a credit or debit balance, depending on whether the instrument is a credit or debit instrument, for example.

Rewards programs have also been used extensively in the gaming industry. For example, casinos typically offer consumers the opportunity to join loyalty programs and earn points towards free rooms, free shows, or other special offers based upon the value of their wagers or bets placed while playing games of chance in the casino. Currently, there are systems available that enable electronic data capture of a member's activity in a casino through the use of loyalty cards. These loyalty cards are inserted into gaming machines inside the casinos, which are read by a card reader located inside the gaming machines to monitor and record a players' activity on the gaming machines.

While there are numerous examples of rewards systems used today, they each suffer from at least one drawback from a merchant's point of view. For example, in a typical credit card rewards program, consumers are generally free to use their rewards points with any merchant participating in the particular rewards program, without needing to physically visit a merchant location to redeem points. Thus, merchants are not able to capitalize on a visit from consumers, which typically results in increased sales.

With regard to casino loyalty programs, on the other hand, the issue of on-site visits by consumers is not a problem, since casino games must be played on site at casinos. However, consumers are restricted to using the games provided by the casino (i.e., slot machines, video poker, table games, etc.) and cannot use a personal communication device, such as tablet computers or smartphones owned by consumers, to earn rewards points. Thus, consumers are relegated to playing only games provided at a casino and cannot play their favorite casino games if they are not playing at a casino.

Thus, it would be desirable for merchants to participate in a rewards program that drives consumers to merchants' premises, while also enabling consumers to access merchant content (i.e., play games, purchase goods or services) conveniently.

### SUMMARY

The embodiments described herein relate to methods and apparatus for providing rewards points, otherwise known as incentive rewards or loyalty points, to consumers located on the premises of a merchant participating in a rewards program.

In one embodiment, a method of operating a loyalty rewards program is described, comprising receiving an electronic order for a purchase of goods or services from a personal communication device operated by a consumer over a communication interface, determining a location of the personal communication device, electronically awarding rewards points by a processor to an account associated with the consumer stored in memory based on purchases of goods or services placed through the personal communication device by the server only if the personal communication device is located at a merchant's premises, the merchant authorized to participate in the loyalty rewards program.

In another embodiment, an apparatus for awarding on-site loyalty points to consumers is described, comprising a communication interface for communicating with one or more personal communication devices, a memory for storing processor-executable instructions and a first passcode, and a processor coupled to the communication interface and the memory configured to generate the first passcode, provide the first passcode to a merchant via the communication interface, receive a second passcode from one of the personal communication devices via the communication interface, compare the second passcode to a the first passcode, send an indication to the personal communication device indicating acceptance of the second passcode if the second passcode matches the first passcode, and award one or more rewards points to an account associated with the user of the personal communication device for subsequent purchases of goods or services by the user of the personal communication device.

In yet another embodiment, an apparatus for awarding on-site loyalty points to consumers comprises a wireless network transceiver for communicating with a server, a memory for storing processor-executable instructions, a user interface for allowing a user to enter a passcode provided to the user by a merchant when the user is at a merchant location, an electronic display for presenting visual information to the user, and a processor coupled to the wireless network transceiver, the memory, the user interface, and the electronic display, configured to receive the passcode from the user, send the passcode to the server, and to receive an indication from the server that the passcode has been accepted, thereby allowing the user to accumulate rewards points for subsequent purchases of goods or services while the user is at the merchant location.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates one embodiment of a system for providing rewards points, otherwise known as incentive rewards or loyalty points, to consumers who are located on the premises of a merchant participating in a reward program;

FIG. 2 is a functional block diagram of one embodiment of one of the servers shown in FIG. 1 in an embodiment where the server acts as a rewards points server and another server acts as a point-of-sale server;

FIG. 3 is a functional block diagram of one embodiment of one of the personal communication devices shown in FIG. 1; and

FIG. 4 is a flow diagram illustrating one embodiment for providing rewards points to consumers who are located on the premises of a merchant participating in a reward program.

### DETAILED DESCRIPTION

The present disclosure relates to a variety of embodiments related to apparatus and methods of providing an on-site rewards program to consumers. The on-site rewards program refers to a reward program that only awards rewards points to consumers who purchase goods and services while they are located on the premises of a merchant. This provides an incentive for consumers to visit merchants, and is advantageous to merchants, as consumers who are on-site may purchase more products or services than if they were not located on-site. Consumers may purchase goods or services from merchants that participate in an on-site rewards program even if they are not located at a merchant's place of business. However, they do not receive rewards points for those purchases.

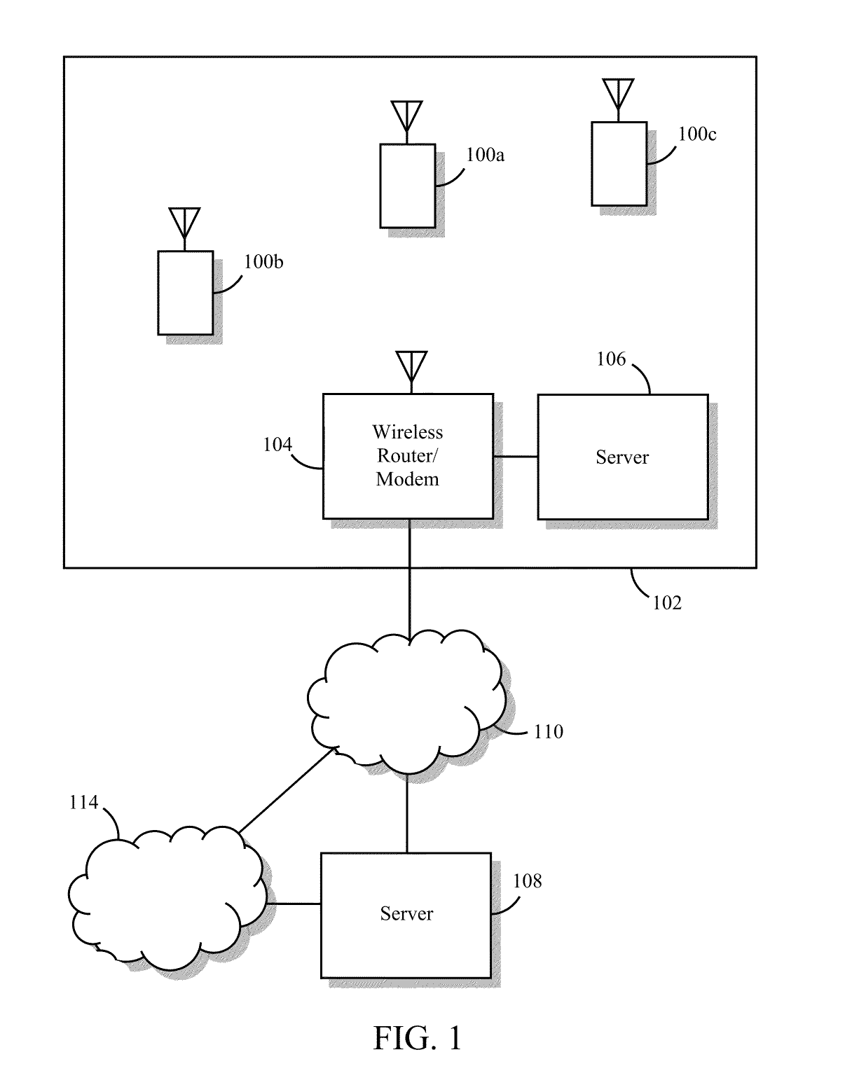

FIG. 1 illustrates one embodiment of a system for providing rewards points, otherwise known as incentive rewards or loyalty points, to consumers who are located on the premises of a merchant participating in such a rewards program. Such rewards programs are commonly used to encourage consumer purchasing behavior to the benefit of merchants participating in such programs. However, in prior art systems, consumers are generally able to accumulate rewards points no matter if they are located at a participating merchant location or not.

Referring back to FIG. 1, consumers each may purchase goods or services from merchants participating in the rewards program using a respective personal communication device 100a, 100b, or 100c. In FIG. 1, each of the personal communication devices 100a, 100b, or 100c are shown located at a participating merchant location 102. For example, each personal communication device may be carried by a respective owner/consumer into a bar, restaurant, sporting event venue, spa, or almost any other merchant of goods or services. The personal communication devices typically comprise a smart phone, such as an iPhone 5 manufactured by Apple Computer, Inc., of Cuppertino, Calif. or a Galaxy S III manufactured by Samsung Electronics of Seoul, South Korea. In other embodiments, personal communication devices may comprise a laptop or tablet computer. In any case, any device may be classified as a personal communication device if it comprises an ability to communicate wirelessly and is able to process purchases for goods or services on behalf of a consumer. Often, the personal communication devices are owned by a single consumer, such as the case where a smartphone is owned by a single person and is generally used exclusively by that person.

One or more of the personal communication devices may communicate with a wireless router/modem 104 located on the premises of merchant 102. Wireless router/modem 104 comprises one of any number of commonly available wireless router/modems on the market today, such as a Linksys Smart Wi-Fi Router N600 manufactured by Cisco Systems of San Jose, Calif. Wireless communication signals are passed through router 104 to/from server 106, shown as being located at the merchant 102 location. However, in another embodiment, all or a portion of the services offered by server 106 could be located in a location away from merchant 102, as shown as server 108. For example, in one embodiment, server 106 may offer consumers located on the premises of merchant 102 the ability to order food or drinks, play a musical or video selection on a jukebox or video display located inside the premises of merchant 102, or to play or participate in electronic game play, either individually, or with/against other consumers, while server 108 operates as a rewards points server that issues rewards points to consumers as they purchase goods or services via their personal communication devices while they are located on the premises of the merchant.

A rewards points account may be created and stored at either server 106 or server 108 to reflect a reward point balance as rewards points are accumulated by each consumer as purchases are made, and to reduce the reward point balance as consumers use rewards points to make future purchases. If server 108 is used, it may communicate with personal communication devices located at merchant 102 via a wide area network 110, such as the Internet, through wireless router/modem/modem 104 located at merchant 102, through server 106 (if used), and then through wireless router/modem 104. Alternatively, or in addition, server 108 may communicate with personal communication devices via a wide area network 110, cellular network 114, then directly to the personal communication devices via a wireless link. In yet another embodiment, server 108 may communicate with personal communication devices cellular network 114 and then to the personal communication devices via a wireless link.

In any case, rewards points are awarded to consumers as they purchase goods or services via their personal communication devices only if they are located at a merchant that participates in the rewards points program. Additionally, consumers may, in one embodiment, order goods or services from merchant 102 even if they are not located on the premises of merchant 102, however they are not awarded rewards points for doing so. For example, a consumer operating personal communication device 100a may be at home and play a game offered by merchant 102 for a fee or select a musical or audio-visual entertainment selection offered by merchant 102 by accessing server 106 via cellular network 114 which is in communication with server 106 as described above. The location of a personal communication device may be determined by one or more methods, as described in further detail below.

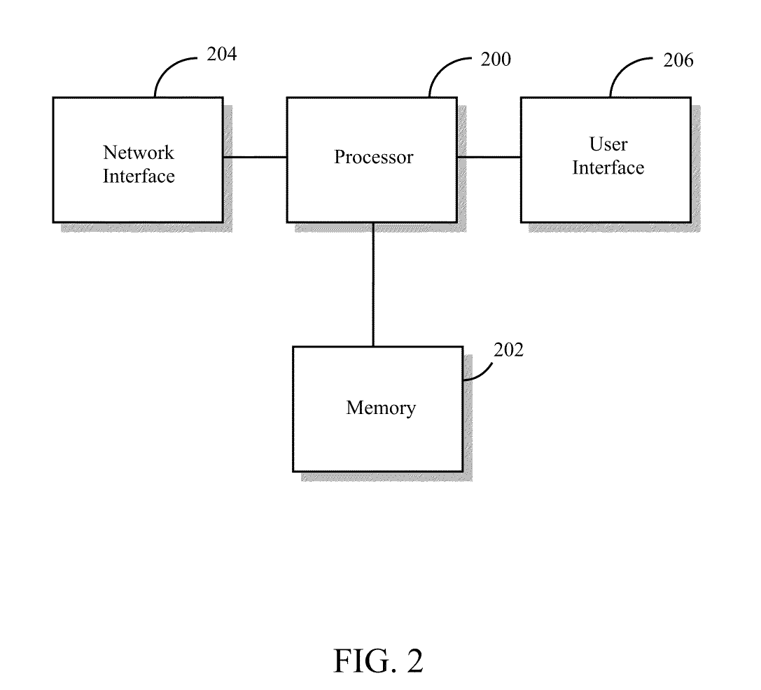

FIG. 2 is a functional block diagram of one embodiment of server 108 in an embodiment where server 108 acts as a rewards points server and server 106 acts as a point-of-sale server that receives purchase orders from consumers via personal communication devices and router 104. It should be understood that server 106 typically comprises the same or similar functionality, hardware, and software as server 108. Specifically, FIG. 2 shows processor 200, memory 202, communication interface 204, and user interface 206. It should be understood that not all of the functional blocks shown in FIG. 2 are required for operation of server 108 (for example, user interface may not be necessary), that the functional blocks may be connected to one another in a variety of ways, and that not all functional blocks necessary for operation of server 108 are shown (such as a power supply), for purposes of clarity.

Server 108 may comprise virtually any commercially-available servers on the market today, including the P4300IP server system manufactured by Intel Corporation of Santa Clara, Calif. Processor 200 provides general operation of server 108 by executing processor-executable instructions stored in memory 202, for example, processor-executable code. Processor 200 typically comprises a general purpose processor, such as any of the Xenon® family of processors manufactured by Intel Corporation of Santa Clara, Calif., although any one of a variety of microprocessors, microcomputers, and/or microcontrollers may be used alternatively.

Memory 202 comprises one or more information storage devices, such as hard drives, RAM memories, ROM memories, flash memories, and/or virtually any other type of electronic, optical, or mechanical memory device. Typically, memory 202 comprises more than one type of memory. For example, memory 202 may comprise a ROM memory used to store processor-executable instructions for operation of server 108, plus RAM memory to store customer account information such as a rewards points account for each consumer that is registered to receive rewards points from server 108.

Communication interface 204 is electronically coupled to processor 200 and comprises electronic circuitry necessary for server 108 to communicate with server 106 and, ultimately, personal communication devices. Typically, communication interface 204 comprises hardware, software and/or firmware necessary to transmit and receive information sent via one or more commonly-used network protocols, such as the well-known TCP/IP suite of protocols. Alternatively, or in addition, communication interface could comprise electronics and supporting software/firmware to support other well-known communication types, including Wi-Fi, Bluetooth, wireless telephone communications, fiber-optic communications, and so on.

User interface 206 is coupled to processor 200 and is used to allow an individual to control operation of server 108 and/or to receive information from server 108. User interface 206 may comprise one or more keyboards, touchscreen devices, pushbuttons, switches, sensors, keypads, and/or microphones that generate electronic signals for use by processor 200 upon initiation by a user. User interface 206 may additionally comprise one or more display devices, seven-segment displays, cathode ray tubes (CRTs), liquid crystal displays (LCDs), light emitting diode displays (LEDDs), light emitting diodes (LEDs), light arrays, or any other type of visual display. Further, user interface 206 could alternatively or in addition comprise an audio device, such as a speaker, for audible presentation of information to a user. Of course, the aforementioned items could be used alone or in combination with each other and other devices may be alternatively, or additionally, used.

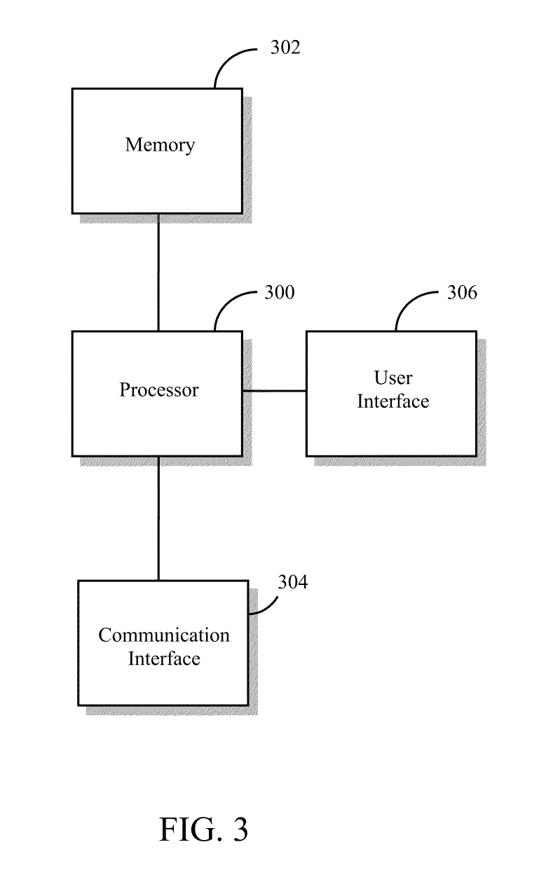

FIG. 3 is a functional block diagram of one embodiment of one of the personal communication devices 100 shown in FIG. 1. Specifically, FIG. 3 shows processor 300, memory 302, communication interface 304, and user interface 306. It should be understood that the functional blocks may be connected to one another in a variety of ways and that not all functional blocks necessary for operation of personal communication device are shown (such as a power supply), for purposes of clarity.

Processor 300 provides general operation of personal communication device 100 by executing processor-executable instructions stored in memory 302, for example, executable code. Processor 300 typically comprises a general purpose processor, such as Tegra 2 processor manufactured by Nvidia Corporation of Santa Clara, Calif., although any one of a variety of microprocessors, microcomputers, and/or microcontrollers may be used alternatively.

Memory 302 comprises one or more information storage devices, such as hard drives, RAM memories, ROM memories, flash memories, and/or virtually any other type of electronic, optical, or mechanical memory device. Typically, memory 302 comprises more than one type of memory. For example, memory 302 may comprise a ROM memory used to store processor-executable instructions for operation of personal communication device 100, plus RAM memory to store executable code used to allow a user to order goods or services, such as food, drink, music, videos, games, etc.

Communication interface 304 is electronically coupled to processor 300 and comprises electronic circuitry necessary for personal communication device 100 to communicate, ultimately, with server 108. Typically, communication interface 304 comprises hardware, software and/or firmware necessary to transmit and receive information sent via one or more commonly-used network protocols, such as the well-known TCP/IP suite of protocols. Alternatively, or in addition, communication interface could comprise electronics and supporting software/firmware to support a variety of well-known communication types, such as CDMA, TDMA, GSM, Ethernet, Wi-Fi, Bluetooth, fiber-optic communications, and so on.

User interface 306 is coupled to processor 300 and is used to allow customers to enter and receive information related to the purchase of goods or services from merchant 102 or a number of other merchants and to receive information regarding rewards points that have been accumulated from previous purchases. User interface 306 may comprise one or more touchscreens, pushbuttons, switches, sensors, keypads, and/or microphones that generate electronic signals for use by processor 300 upon initiation by a user. User interface 306 may additionally comprise one or more liquid crystal displays (LCDs), one or more light emitting diode displays (LEDDs), one or more light emitting diodes (LEDs), light arrays, or any other type of visual display. Further, user interface 306 could, alternatively or in addition, comprise an audio device, such as a speaker, for audible presentation of information to customers. Of course, the aforementioned items could be used alone or in combination with each other and other devices may be alternatively, or additionally, used. Typically, input device 306 comprises a widely-known touchscreen device capable of displaying information and receiving user input.

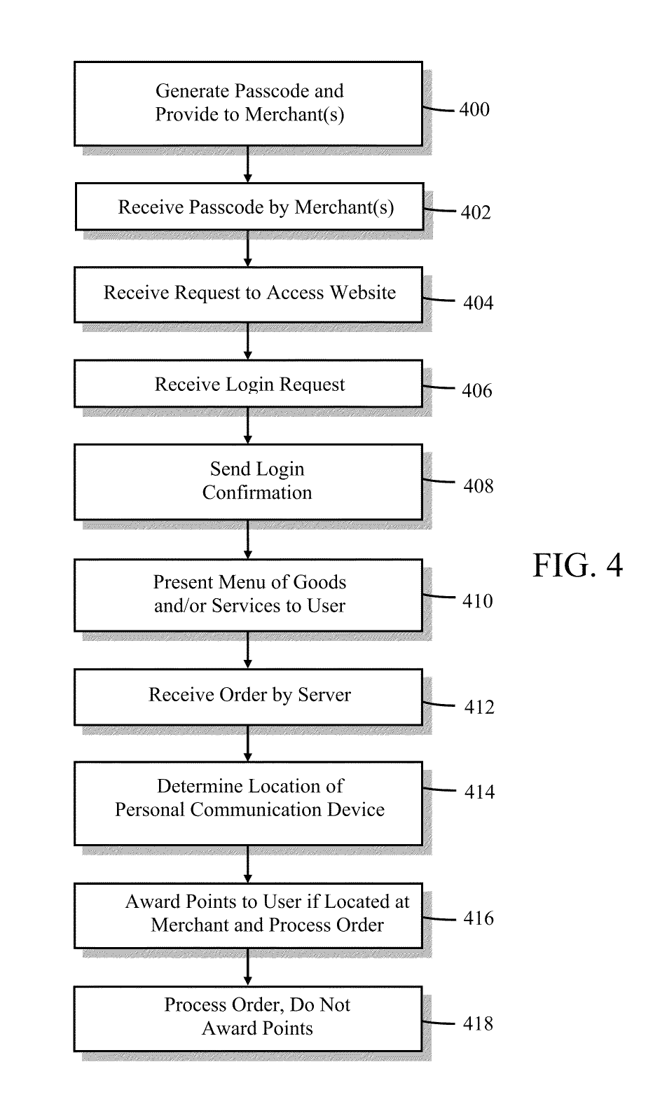

FIG. 4 is a flow diagram illustrating one embodiment for providing rewards points to consumers who purchase goods and services while located on the premises of a merchant participating in a rewards program managed by server 108. Processor 200 within server 108 executes processor-executable instructions stored in memory 202 that causes server 108 to perform the method. Server 108 is in communication with one or more personal communication devices, such as the ones shown in FIG. 1, via wireless router/modem 108 and/or via a wireless communication network, such as cellular network 114. It should be understood that in some embodiments, not all of the steps shown in FIG. 4 are performed, and that the order in which the steps are carried out may be different in other embodiments. It should be further understood that some minor method steps may have been omitted for purposes of simplifying the method description.

At block 400, server 108 generates a passcode for at least one merchant that is a member of a particular rewards program. In one embodiment, one passcode is provided to all merchants that participate in the rewards program. In another embodiment, server 108 generates a different passcode for different merchants participating in the rewards program. In yet another embodiment, passcodes are generated upon the occurrence of one or more events, such as the passage of a predetermined time period from when a previous passcode was provided to one or more merchants, upon demand from one or more merchants, etc. The passcode may comprise of a numeric, or alpha-numeric sequence, a visual representation (such as a photograph or drawing of a particular object, animal, etc.) or audible representation (such as the sound that an animal makes, or any other recognizable sound), or some other variation that provides a unique passcode to the merchants. The passcode is used to determine if a consumer is located on the premises of a merchant participating in a rewards program maintained by server 108 and/or server 106 while the consumer places orders for goods or services.

The passcode may be provided to merchants in any number of ways, such as by email, text, automated telephone call, website update, etc.

At block 402, the passcode generated at block 400 is received by one or more merchants who are participants in a rewards program. For example, the passcode may be received by one or more employees via email or phone call, or to management a desktop, laptop, or tablet computer, to one or more display devices located throughout a bar/restaurant, etc. After the passcode has been received, it may be provided to customers present in/on the merchant's premises in any number of ways, including by direct, verbal communication between merchant employees and customers, by posting the passcode on a bulletin board, blackboard, or one or more electronic display devices located throughout the merchant's premises, by transmitting the passcode to personal communication devices by wireless router/modem 104, or any other method that reasonably ensures that personal communication device 100 and, therefore, the user of personal communication device 100, is located on the premises of merchant 102.

At block 404, in one embodiment, server 108 receives a request to access a website hosted by server 108 from a customer located on/in the premises of a merchant participating in the rewards program, such as merchant 102. The request is transmitted from a personal communication device 100 operated by the customer. In one embodiment, the request comprises a request message from a web browser in accordance with the well-known HTTP protocol. In another embodiment, the website is accessed by launching an application, or “app” on the personal communication device that may also use the HTTP protocol to access content stored on server 106 and/or server 108.

In another embodiment, server 108 does not host the website being accessed by the customer, but only receives information pertaining to a purchase of goods or services for purposes of awarding rewards points to the customer.

The website accessed by the customer, or the app, typically comprises an initial welcome screen that may allow the customer to login to an account managed by merchant 102, or some other entity, that allows customers to make purchases offered by merchant 102 through the website/app.

At block 406, a login request (e.g., username and password) is received from the personal communication device by server 108, and the login request is processed in order to access one or more accounts held by the user who supplied the login information. In one embodiment, the user may have an account managed by merchant 102 (e.g., via server 106) and a rewards points account managed by server 108. In another embodiment, the user has only one account managed by either server 106 or server 108, where both purchases and rewards points are managed by merchant 102.

At block 408, server 108 sends a message to the personal communication device that the login was successful if, in fact, server 108 determines that the login information received at block 406 matches account information stored within a memory accessible by server 108, such as memory 202 or a memory external to server 108.

At block 410, after a successful login, the user may be presented with a menu of selections for purchase via a display screen of personal communication device 100, such as food or drink items, music or video entertainment, and/or games if merchant 102 is a restaurant or a bar. Music or video entertainment may be purchased and provided wirelessly from, for example, server 106 to personal communication device 100, or the music or video entertainment may be displayed in a central location, such as a bar for others to enjoy as well. In that case, merchant 102 may provide a digital jukebox that receives music selections from personal communication devices and plays the selections through the jukebox. Merchant 102 may, alternatively or in addition, provide one or more video display screens located within, for example, a bar area, for presentation of selected video entertainment selected by users via their personal communication devices. Games may be provided by server 106 to a personal communication device for execution by the personal communication device. Games may be in the form of a solitary-type game, where each user plays the game without competition from other game players. Games in this category may include well-known games such as Tetris, any number of solitaire-type games, Keno, Blackjack, poker, etc. Or, games may be in the form of competitive-type games, where one game player competes against one or more other game players, each game player using a personal communication device, and/or other gaming device, such as a laptop or tablet computer over wide area network 110. Games in this category include trivia-based games.

At block 412, server 108 receives a request from the personal communication device 100 for an order to purchase goods or services from merchant 102. For example, the request may comprise an order for food or beverages, a selection of a song or video for playback via a personal communication device or a communal device, such as a digital jukebox or video display(s), or a request to play a game. The request may also contain identification information that identifies a customer, at least for purposes associated with awarding rewards points to the customer's account. For example, the identification information could comprise a name, alpha-numeric code, telephone number, account number, a MAC address of the personal communication device owned by the customer, or any other means to identify the customer to server 108. In another embodiment, server 108 receives only information relating to a purchase, such as identification information relating to the customer and the cost of the purchase, so that server 108 may award rewards points to the customer's account.

At block 414, server 108, or, in another embodiment, server 106, determines a location of the personal communication device 100 that sent the order to purchase goods or services. In one embodiment, server 108/106 sends a message to personal communication device 100 requesting that the user of personal communication device 100 provide a previously-generated passcode to server 108/106. In a related embodiment, a screenshot is displayed on a user's personal communication device 100 requesting that the user enter the passcode to server 108/106. A passcode may have been provided to the user by a merchant employee, or other means, as described earlier with respect to blocks 400 and 402, above.

Server 108/106 may determine the location of the personal communication device 100 that sent the order to purchase goods or services in other ways as well. For example, server 108 may determine that personal communication device 100 is located on the premises of merchant 102 if personal communication device 100 is communicating through wireless router/modem 104. This may be determined by evaluating an IP address assigned to personal communication device 100 by wireless router/modem 104 during initial communications between personal communication device 100 and wireless router/modem 104. Further, personal communication device 100 may be equipped with well-known location technology, such as GPS or multilateration, that can provide a user's location to server 108/106.

At block 416, if server 108/106 determines that the personal communication device 100 that sent the request for goods or services at block 412 is located at a merchant's premises that participates in the rewards program, one or more rewards points are added to a rewards points account associated with the user of the personal communication device 100 that sent the request for goods or services. For example, if the user chose to play a trivia game against other players, and server 108/106 determines that the personal communication device operated by the user is in/on the premises of a merchant belonging to the rewards program, then either server 108 or server 106 will award a number of rewards points to the rewards points account held by the user, typically in proportion to the cost of playing the game.

At block 418, if server 108/106 determines that the personal communication device 100 that sent the request for goods or services at block 412 is not located at a merchant's premises that participate in the rewards program, no rewards points are added to the user's rewards points account. However, the order for goods and services may still be accepted, either by server 108 or server 106, and the goods or services provided to the user of personal communication device 100.

In one embodiment, at some random or pre-determined time after server 108/106 determines that the personal communication device 100 is located at the merchant's premises at blocks 414 and 416, server 108/106 may require a user of personal communication device 100 to enter another passcode to re-confirm that the user and personal communication device 100 are still at the merchant's location. In one embodiment, server 108/106 generates a new passcode after the random or pre-determined time period has elapsed, and sends it to merchant 102 for dissemination to customers on the premises of merchant 102. At that point, server 106/108 may suspend awards of rewards points until user's re-confirm the new passcode. At some point, server 108/106 may send a message to personal communication device 100 requesting that the user of personal communication device 100 send the new password to server 108/106.

In a related embodiment, personal communication device 100 periodically requests that the user of personal communication device 100 enter the new passcode via an application being executed by the personal communication device 100. The user enters the new passcode and uses personal communication device 100 to provide it to server 108/106 for verification. In yet another embodiment, each time that a user of personal communication device 100 orders a product or service, the most-recent passcode is entered along with the order, and the location of personal communication device 100 is verified at the time the order is submitted.

The methods described in connection with the embodiments disclosed herein may be embodied directly in hardware or embodied in processor-executable instructions stored in one or more memories and executed by one or more processors. The processor-executable instructions may reside in RAM memory, flash memory, ROM memory, EPROM memory, EEPROM memory, registers, hard disks, removable disks, CD-ROMs, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, such as personal communication device 100 or in server 106 or server 108. In the alternative, the processor and the storage medium may reside as discrete components.

Accordingly, an embodiment of the invention may comprise a computer-readable media embodying code or processor-executable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated. Finally, it should be understood that in the functionality or methods may be distributed between various components, such as between server 106 and server 108.

We claim:

1. A method of providing a loyalty rewards program by a computer server, comprising:
receiving an electronic order for a purchase of goods or services from a personal communication device operated by a consumer over a communication interface;
determining a location of the personal communication device;
electronically awarding rewards points by a processor to an account associated with the consumer stored in memory based on purchases of goods or services placed through the personal communication device by the server only if the personal communication device is located at a merchant's premises, the merchant authorized to participate in the loyalty rewards program.

2. The method of claim 1, wherein determining the location of the personal communication device comprises:
providing a passcode to the merchant via the communication interface;
receiving a passcode from the personal communication device via the communication interface;
comparing the passcode provided to the merchant with the passcode received from the personal communication device by the processor; and
determining that the personal communication device is located at the merchant if the passcode provided to the merchant and the passcode received from the personal communication device match.

3. The method of claim 2, wherein providing the passcode to the merchant comprises:
providing a first passcode to the merchant via the communication interface;
determining that a pre-determined time period has elapsed by the processor; and
providing a second passcode to the merchant via the communication interface when the pre-determined time period has elapsed.

4. The method of claim 3, further comprising:
receiving a third passcode from the personal communication device via the communication interface;
comparing the third passcode to the second passcode by the processor; and
electronically awarding rewards points by the processor to the account based on purchases of goods or services placed through the personal communication device only if the third passcode matches the second passcode.

5. The method of claim 4, further comprising:
suspending an award of rewards points after providing the second passcode to the merchant until the processor determines that the personal communication device is still at the merchant's premises.

6. The method of claim 1, wherein purchases of the goods or services may be made via the personal communication device when the personal communication device is not located at the merchant's premises.

7. The method of claim 1, wherein determining a location of the personal communication device comprises:
assigning an IP address to the personal communication device;
receiving a second IP address in a communication from the personal communication;
comparing the second IP address to the IP address; and
determining that the personal communication device is at the merchant's premises if the second IP address matches the IP address.

8. The method of claim 1, wherein rewards points are not awarded to the account when the personal communication device is not located at the merchant's premises.

9. An apparatus for awarding on-site loyalty points to consumers, comprising:
a communication interface for communicating with one or more personal communication devices;
a memory for storing processor-executable instructions and a first passcode; and
a processor coupled to the communication interface and the memory configured to:
generate the first passcode;
provide the first passcode to a merchant via the communication interface;
receive a second passcode from one of the personal communication devices via the communication interface;
compare the second passcode to a the first passcode;
send an indication to the personal communication device indicating acceptance of the second passcode if the second passcode matches the first passcode; and
award one or more rewards points to an account associated with the user of the personal communication device for subsequent purchases of goods or services by the user of the personal communication device.

10. The apparatus of claim 9, wherein the processor is further configured to:
generate a new first passcode upon expiration of a predetermined time period;
replace the first passcode stored in memory with the new first passcode; and
send the new first passcode to the merchant;
wherein the new first passcode is used to compare subsequently-received passcodes from personal communication devices in subsequent transactions.

11. The apparatus of claim 9, wherein the processor is further configured to process purchases for the goods or services received from the personal communication device even if the second passcode does not match the first passcode, and to refrain from awarding rewards points to the account if the second passcode does not match the first passcode.

12. The apparatus of claim 10, wherein the processor is further configured to:
receive a third passcode from the personal communication device;
compare the third passcode to the new first passcode; and
electronically award rewards points to the account based on purchases of goods or services placed through the personal communication device only if the third passcode matches the new first passcode.

13. The apparatus of claim 10, wherein the processor is further configured to:
suspend an award of rewards points after providing the new first passcode to the merchant until the processor determines that the personal communication device is still at the merchant's premises.

14. An apparatus for awarding on-site loyalty points to consumers, comprising:
a wireless network transceiver for communicating with a server;
a memory for storing processor-executable instructions;
a user interface for allowing a user to enter a passcode provided to the user by a merchant when the user is at a merchant location;
an electronic display for presenting visual information to the user; and
a processor coupled to the wireless network transceiver, the memory, the user interface, and the electronic display, configured to receive the passcode from the user, send the passcode to the server, and to receive an indication from the server that the passcode has been accepted, thereby allowing the user to accumulate rewards points for subsequent purchases of goods or services while the user is at the merchant location.

15. The apparatus of claim 14, wherein the user is able to purchase goods or services via the apparatus if the passcode is not accepted or if the passcode has not been entered into the apparatus by the user.

16. The apparatus of claim 15, wherein no rewards points are accumulated by the user if the user purchases goods or services from the merchant via the apparatus if the passcode was not accepted or if the passcode was not entered into the apparatus by the user.

17. The apparatus of claim 14, wherein the processor is further configured to:
generate a new first passcode upon expiration of a predetermined time period;
replace the first passcode stored in memory with the new first passcode; and
send the new first passcode to the merchant;
wherein the new first passcode is used to compare subsequently-received passcodes from personal communication devices in subsequent transactions.

18. The apparatus of claim 17, wherein the processor is further configured to:
receive a third passcode from the personal communication device;
compare the third passcode to the new first passcode; and
electronically award rewards points to the account based on purchases of goods or services placed through the personal communication device only if the third passcode matches the new first passcode.

19. The apparatus of claim 17, wherein the processor is further configured to:
suspend an award of rewards points after providing the new first passcode to the merchant until the processor determines that the personal communication device is still at the merchant's premises.
